(19) United States
(12) Patent Application Publication
(10) Pub. No.: US 2026/0087597 A1
(43) Pub. Date: Mar. 26, 2026

(54) METHOD AND DEVICE WITH IMAGE PROCESSING

(71) Applicant: SAMSUNG ELECTRONICS CO., LTD., Suwon-si (KR)

(72) Inventors: Insoo KIM, Suwon-si (KR); Hana LEE, Suwon-si (KR); Hyong Euk LEE, Suwon-si (KR)

(73) Assignee: SAMSUNG ELECTRONICS CO., LTD., Suwon-si (KR)

(21) Appl. No.: 19/295,828

(22) Filed: Aug. 11, 2025

(30) Foreign Application Priority Data
Sep. 20, 2024 (KR) 10-2024-0127675
Nov. 20, 2024 (KR) 10-2024-0166120

(51) Int. Cl. G06T 5/60; G06T 3/18; G06T 5/70; G06T 5/73; G06T 7/20; G06T 7/70

(52) U.S. Cl. CPC G06T 5/60; G06T 3/18; G06T 5/70; G06T 5/73; G06T 7/20; G06T 7/70; G06T 2207/20081; G06T 2207/20084; G06T 2207/20201; G06T 2207/20212; G06T 2207/30168; G06T 2207/30241; G06T 2207/30244

(57) ABSTRACT

A method and device with image processing are provided. The method includes receiving a blur image generated by capturing a target scene along a three-dimensional (3D) camera trajectory during an exposure time; estimating, using a neural network-based motion estimation model, camera poses corresponding to image components captured at camera positions on the 3D camera trajectory, wherein the image components form the blur image; and generating, based on the camera poses, vector fields representing a difference between an initial image component captured at a starting point of the 3D camera trajectory and the image components captured at the camera positions.

### CROSS-REFERENCE TO RELATED APPLICATIONS

This application claims the benefit under 35 USC § 119(a) of Korean Patent Application No. 10-2024-0127675, filed on Sep. 20, 2024, and 10-2024-0166120, filed on Nov. 20, 2024, in the Korean Intellectual Property Office, the entire disclosures of which are incorporated herein by reference for all purposes.

### BACKGROUND

### 1. Field

The following description relates to a method and device with image processing.

### 2. Description of Related Art

A deep learning-based neural network may be utilized for image processing. The neural network is initially trained using deep learning techniques, and subsequently performs inference by mapping input data to output data through nonlinear relationships. This capability to establish a mapping may be referred to as the neural network's learning ability. Moreover, a neural network trained for a specialized purpose, such as image enhancement, may exhibit generalization capabilities, enabling it to produce relatively accurate outputs in response to input patterns that were not explicitly encountered during training.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented image processing method includes receiving a blur image generated by capturing a target scene along a three-dimensional (3D) camera trajectory during an exposure time; estimating, using a neural network-based motion estimation model, camera poses corresponding to image components captured at camera positions on the 3D camera trajectory, wherein the image components form the blur image; and generating, based on the camera poses, vector fields representing a difference between an initial image component captured at a starting point of the 3D camera trajectory and the image components captured at the camera positions.

The method may further include determining two-dimensional (2D) transformation components of the vector fields based on the camera poses; and estimating 3D residual components of the vector fields using the neural network-based motion estimation model.

The generating of the vector fields may comprise fusing the 2D transformation components with the 3D residual components.

The method may further comprise generating warped images by warping a target sharp image using the vector fields; and generating a target blur image by synthesizing the warped images.

In the method, a training data pair comprising the target sharp image and the target blur image may be used to train a neural network-based deblur model.

The method may further comprise generating transformed vector fields by adjusting one or more of an amplitude and a phase of the vector fields; generating new warped images by warping a target sharp image using the transformed vector fields; and generating a new target blur image by synthesizing the new warped images.

The method may further comprise generating warped images by warping a sharp image using the transformed vector fields; generating an estimated blur image by merging the warped images; and training the neural network-based motion estimation model by adjusting model parameters of the motion estimation model to a difference between the blur image and the estimated blur image, wherein the blur image and the sharp image form a training data pair.

The neural network-based motion estimation model may be trained based on one or more of: an inverse transformation constraint that reduces a difference between images obtained by applying an inverse transformation using the vector fields to the warped images and the sharp image; and a smoothing constraint that reduces a difference between neighboring vectors of the vector fields.

The method may further comprise, based on the blur image and the vector fields, generating a deblurred image by executing a neural network-based deblur model.

In one general aspect, provided a non-transitory computer-readable storage medium storing instructions that, when executed by one or more processors, cause the one or more processors to perform all operations and methods described herein.

In one general aspect, an electronic device include one or more processors respectively comprising processing circuitry; and a memory storing executable code, which upon execution by the one or more processors, configures the one or more processors to: receive a blur image generated by capturing a target scene along a three-dimensional (3D) camera trajectory during an exposure time; estimate, using a neural network-based motion estimation model, camera poses corresponding to image components captured at camera positions on the 3D camera trajectory, wherein the image components form the blur image; and generate, based on the camera poses, vector fields representing a difference between an initial image component captured at a starting point of the 3D camera trajectory and the image components captured at the camera positions.

The execution of the code by the one or more processors may configure the one or more processors: determine two-dimensional (2D) transformation components of the vector fields based on the camera poses; and estimate 3D residual components of the vector fields using the motion estimation model.

The execution of the code by the one or more processors may configure the one or more processors: generate the vector fields by fusing the 2D transformation components with the 3D residual components.

The execution of the code by the one or more processors may configure the one or more processors: generate warped images by warping a target sharp image using the vector fields; and generate a target blur image by synthesizing the warped images.

In the electronic device, a neural network-based deblur model may be trained using a training data pair comprising the target sharp image and the target blur image.

The execution of the code by the one or more processors may configure the one or more processors: generate transformed vector fields by adjusting one or more of an amplitude and a phase of the vector fields; generate new warped images by warping a target sharp image using the vector fields; and generate a new target blur image by synthesizing the new warped images.

The execution of the code by the one or more processors configures the one or more processors: generate warped images by warping a sharp image using the vector fields; generate an estimated blur image by merging the warped images; and train the motion estimation model by adjusting model parameters of the motion estimation model to reduce a difference between the blur image and the estimated blur image, wherein the blur image and the sharp image form a training data pair.

The motion estimation model may be trained based on one or more of: an inverse transformation constraint that reduces a difference between images obtained by applying an inverse transformation using the vector fields to the warped images and the sharp image; and a smoothing constraint that reduces a difference between neighboring vectors of the vector fields.

The execution of the code by the one or more processors may configure the one or more processors: generate a deblurred image based on the blur image and the vector fields by executing a neural network-based deblur model.

In one general aspect, a method for generating a three-dimensional (3D) aware vector field for a blur image includes: capturing a blur image of a target scene along a 3D camera trajectory during an exposure interval; estimating a vector field representing differences between an initial image component captured at a starting point of the 3D camera trajectory and subsequent image components captured at camera positions along the 3D camera trajectory, the estimating being performed using a neural network-based motion estimation model; adjusting one or more of an amplitude and a phase of the vector field to generate a controllable vector field; and using the controllable vector field to configure a training dataset for a deblur model, wherein the training dataset comprises a training data pair including the blur image and a sharp image of the target scene by applying the controllable vector field.

In one general aspect, an electronic device includes: one or more processors; and a memory storing executable code which, when executed by the one or more processors, cause the electronic device to: capture a blur image of a target scene along a 3D camera trajectory during an exposure time; estimate a vector field representing differences between an initial image component captured at a starting point of the 3D camera trajectory and subsequent image components captured at camera positions along the 3D camera trajectory using a neural network-based motion estimation model; adjust one or more of an amplitude and a phase of the vector field to generate a controllable vector field; and use the controllable vector field to configure a training dataset for a deblur model, wherein the training dataset comprises a training data pair including the blur image and a sharp image by applying the controllable vector field.

Other features and aspects will be apparent from the following detailed description, the drawings, and the claims.

### BRIEF DESCRIPTION OF THE DRAWINGS

FIG. 1 illustrates an example operation of generating vector fields of a blur image according to one or more embodiments.

FIG. 2 illustrates an example three-dimensional (3D) camera trajectory according to one or more embodiments.

FIG. 3 illustrates an example vector field including blur vectors according to one or more embodiments.

FIG. 4 illustrates an example operation of generating vector fields by using a motion estimation model according to one or more embodiments.

FIG. 5 illustrates an example operation of estimating a blur image by using vector fields according to one or more embodiments.

FIG. 6 illustrates an example inverse transformation constraint that provides geometric consistency according to one or more embodiments.

FIG. 7 illustrates an example operation of performing blur synthesis by using a control parameter according to one or more embodiments.

FIG. 8 illustrates an example deblur model that uses vector fields according to one or more embodiments.

FIG. 9 illustrates an example image processing method using vector fields according to one or more embodiments.

FIG. 10 illustrates an example configuration of an electronic device according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

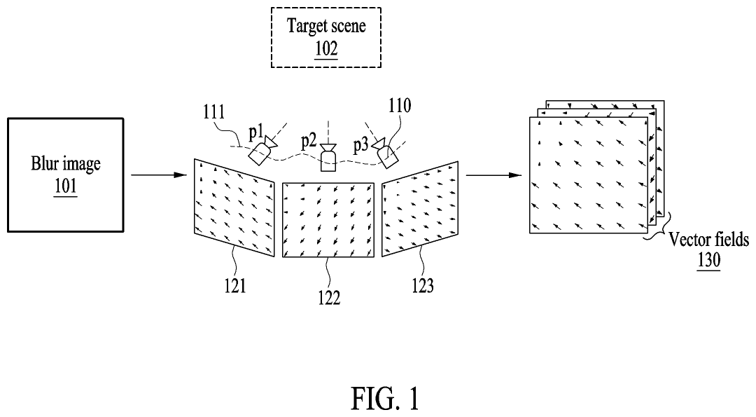

FIG. 1 illustrates an example operation for generating vector fields of a blur image according to one or more embodiments. Referring to FIG. 1, a camera 110 may capture a target scene 102 while moving along a three-dimensional (3D) camera trajectory 111 during an exposure time/interval, thereby generating a blur image 101.

The blur image 101 may include a blur component attributable to a movement of the camera 110 during the exposure interval/time. In addition, the blur image 101 may include a blur component that is unrelated to the movement of the camera 110. A motion resulting from the movement of the camera 110 may correspond to a global motion, while a motion unrelated to the movement of the camera 110 may correspond to an object (or local) motion. Thus, the blur image 101 may include both global and object motion-induced blur components. In this context, the 3D camera trajectory 111 may represent the global motion. For example, the 3D camera trajectory 111 may be caused by a camera shake.

In one embodiment, physical-driven blur modeling may be performed based on the 3D camera trajectory 111. Conventional kernel-based blur modeling, which analyzes a blur kernel for each pixel of the blur image 101, does not incorporate the 3D camera trajectory 111. Because the blur component results from projecting the camera 110's 3D motion onto a two-dimensional (2D) image, thereby exhibiting non-uniform characteristics, accurate estimate of the blur component is challenging without considering the 3D motion. In contrast, the physical-driven blur modeling leverages the actual 3D camera trajectory 111 to facilitate precise analysis of the blur component. Moreover, vector fields 130 generated using the physical-driven blur modeling may provide controllability over a motion component.

In one embodiment, the blur image 101 may be decomposed into first, second, and third image components corresponding to camera positions p1, p2, and p3 along the 3D camera trajectory 111. The blur image 101 is then formed by merging (e.g., averaging) these image components. While FIG. 1 illustrates an example using three image components, the present disclosure is not limited thereto.

In one embodiment, first, second, and third camera poses corresponding to the image components captured at the camera positions p1, p2, and p3 along the 3D camera trajectory 111 may be estimated using a neural network-based motion estimation model.

The first, second, and third image components may be generated by capturing the target scene 102 using the corresponding camera poses at the camera positions p1, p2, and p3. Although these image components may not actually be output during a process of generating the blur image 101, they may be conceptualized as virtual images that form the blur image 101. The first, second, and third image components provide valuable information for analyzing the blur image 101 with the analysis being performed via the vector fields 130 derived therefrom.

In one embodiment, first, second, and third vector fields 121, 122, and 123 respectively, may be generated based on the corresponding camera poses. In an example, the first vector field 121 may be generated based on the first camera pose at the first camera position p1, the second vector field 122 may be generated based on the second camera pose at the second camera position p2, and the third vector field 123 may be generated based on the third camera pose at the third camera position p3. The aggregate vector fields 130 may correspond to these individual vector fields 121, 122, and 123.

The vector fields 121, 122, and 123 may represent the differences between an initial image component corresponding to a starting point of the 3D camera trajectory 111 and the image components at the camera positions p1, p2, and p3, respectively. In an example, the first vector field 121 may represent a difference between the initial image component and the first image component, the second vector field 122 may represent a difference between the initial image component and the second image component, and the third vector field 123 may represent a difference between the initial image component and the third image component.

In one embodiment, the vector fields 130 may be utilized for data augmentation. Training a deblur model to restore the blur image 101 typically requires training data pairs comprising the blur image 101 and a corresponding sharp image. Deblurring performance of the deblur model depends, in part, on a size of a training database including the training data pairs. When a target sharp image is given, a target blur image corresponding to the target sharp image may be generated using the vector fields 130. As described below, various versions of target blur images may be generated by exploiting the controllability of the vector fields 130.

In one embodiment, the vector fields 130 may serve as an input to the deblur model. As described below, the vector fields 130 may include 3D motion information that causes the blur component of the blur image 101, thereby exhibiting a 3D aware-based characteristic. The deblur model may use the vector fields 130 having the 3D aware-based characteristic for effectively remove the blur component from the blur image 101.

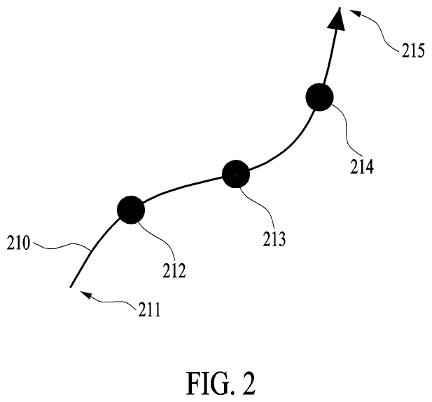

FIG. 2 illustrates an example 3D camera trajectory according to one or more embodiments. Referring to FIG. 2, a 3D camera trajectory 210 may include a starting point 211 and an ending point 215. First, second, and third image components may be defined by corresponding camera poses at positions 212, 213, and 214 along the 3D camera trajectory 210. An initial image component may be defined by an initial pose at the starting point 211. A vector field associated with each image component may represent the differences between pixel values of the initial image component and those of the corresponding image component.

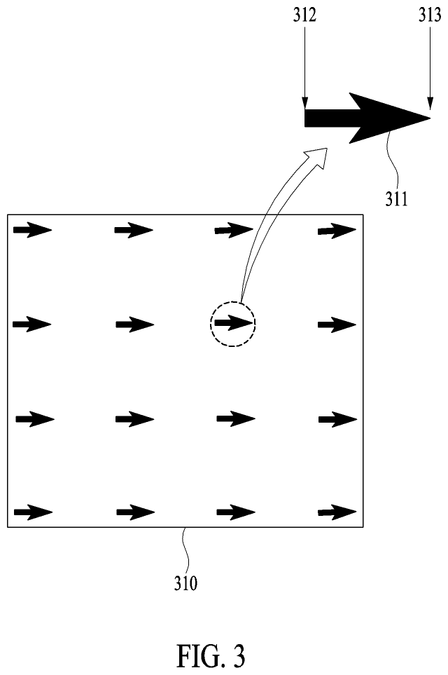

FIG. 3 illustrates an example vector field including blur vectors according to one or more embodiments. Referring to FIG. 3, a vector field 310 may include blur vectors, such as a blur vector 311. The blur vector 311 may include a starting point 312 and an ending point 313. The vector field 310 may represent a difference between a reference image component (e.g., the initial image component) and a target image component (e.g., one of the first to third image components). For example, the starting point 312 may correspond to a pixel position in the reference image component, and the ending point 313 may correspond to a pixel position in the target image component. By applying the blur vector 311, a pixel position at the starting point 312 in the reference image component may be transformed (e.g., warped) to the corresponding pixel position of the target image component at the ending point 313. In this manner, each pixel in the reference image component may be, using blur vectors of the vector field 310, mapped to a corresponding pixel in the target image component.

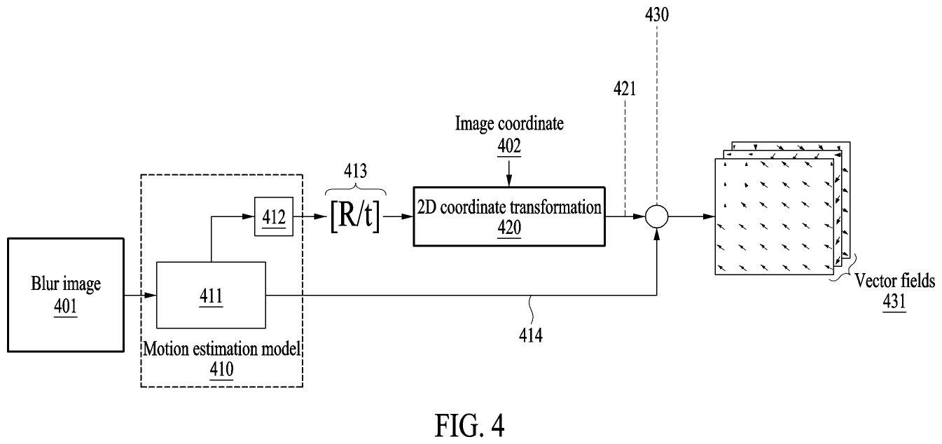

FIG. 4 illustrates an example operation for generating vector fields using a motion estimation model according to one or more embodiments. Referring to FIG. 4, a motion estimation model 410 may estimate camera poses 413 associated with image components corresponding to camera positions along a 3D camera trajectory that forms a blur image 401. For example, the camera poses 413 may each include a rotation parameter R and a translation parameter t.

The blur image 401 may include a blur component attributable to both a global motion and an object motion, each corresponding to a 3D motion. The camera poses 413 may represent a 2D motion portion of the global motion blur component. The motion estimation model 410 may utilize these parameterized camera poses 413 to estimate the 2D motion portion of the global motion blur component.

Parametric vector fields 421 may be generated by performing a 2D coordinate transformation 420 based on the camera poses 413 and an image coordinate 402. The image coordinate 402 may include 2D coordinates corresponding to the blur image 401 and/or vector fields 431. The rotation parameter R and the translation parameter t of the camera poses 413 may be expressed as blur vectors in the 2D coordinates, based on the 2D coordinate transformation 420. The motion estimation model 410 may generate non-parametric vector fields 414 by estimating the object motion blur component and a remaining one-dimensional (1D) motion portion of the global motion blur component.

The motion estimation model 410 may include a main neural network 411 and a sub-neural network 412. The motion estimation model 410 may estimate non-parametric vector fields 414 by using the main neural network 411 and estimate the parametric vector fields 421 by using the main neural network 411 and the sub-neural network 412. The vector fields 431 may be generated by fusing the parametric vector fields 421 with the non-parametric vector fields 414.

The parametric vector fields 421 may include 2D transformation components of the vector fields 431. For example, the 2D transformation components may include a rotation transformation component and a translation transformation component of each 2D coordinate. Conversely, the non-parametric vector fields 414 may include 3D residual components of the vector fields 431. When estimating the camera poses 413 using the motion estimation model 410, the 2D transformation components of the vector fields 431 may be determined based on the camera poses 413. In addition, the 3D residual components of the vector fields 431 may be estimated using the motion estimation model 410. The vector fields 431 may be generated by fusing 430 (e.g., summing) the 2D transformation components with the 3D residual components. This fusion, which is guided by the camera poses 413 and the parametric vector fields 421, significantly reduces ambiguity in the estimation of vector fields 431.

The blur image 401 may be expressed as Equation 1 below.

$$B = {\int }_{0}^{T} S ( {𝒯}_{τ} ) {d}_{τ} \qquad Equation 1$$

In Equation 1, B denotes the blur image 401, T denotes an exposure time, [symbol] denotes a vector field, τ denotes a time, [symbol] ( [symbol] ) denotes an image component of the blur image 401 at the time τ. The vector fields 431 may be expressed as { [symbol] , . . . , [symbol] }. T may be discretely divided into M. M may denote a number of camera positions on a camera trajectory, a number of image components, or a number of the vector fields 431. { [symbol] ( [symbol] ), . . . , [symbol] ( [symbol] )} may be estimated using { [symbol] , . . . , [symbol] }.

When a global motion (e.g., a camera motion) is modeled with a simple 2D rigid transformation, the vector fields 431 may be expressed as Equation 2 below. The rigid transformation may refer to transformation based on a rotation and a translation.

$$Equation 2$$

$${𝒯}_{τ} ( u ) = [ {R}_{τ} \vert {t}_{τ} ] u = [ \begin{matrix}{r}_{τ}^{( 11 )} & {r}_{τ}^{( 12 )} & {t}_{τ}^{( 1 )} \\ {r}_{τ}^{( 21 )} & {r}_{τ}^{( 22 )} & {t}_{τ}^{( 2 )}\end{matrix} ] [ \begin{matrix}x \\ y \\ 1\end{matrix} ] = [ \begin{matrix}{r}_{τ}^{( 11 )} x + {r}_{τ}^{( 12 )} y + {t}_{τ}^{( 1 )} \\ {r}_{τ}^{( 21 )} x + {r}_{τ}^{( 22 )} y + {t}_{τ}^{( 2 )}\end{matrix} ]$$

In Equation 2, [symbol] (u) denotes the vector fields 431, u denotes a 2D coordinate position, γ_{τ} denotes a rotation parameter of a time τ, and t_{τ} denotes a translation parameter of the time τ. A number in the parentheses may represent an identifier of each element.

An actual global motion may be a 3D rigid transformation. When the actual global motion is modeled with the 3D rigid transformation, the vector fields 431 may be expressed as Equation 3 below.

$$Equation 3$$

$${𝒯}_{τ} ( X ) = [ {R}_{τ} \vert {t}_{τ} ] \text{} X = [ \begin{matrix}{r}_{τ}^{( 11 )} & {r}_{τ}^{( 12 )} & {r}_{τ}^{( 13 )} & {t}_{τ}^{( 1 )} \\ {r}_{τ}^{( 21 )} & {r}_{τ}^{( 22 )} & {r}_{τ}^{( 23 )} & {t}_{τ}^{( 2 )} \\ {r}_{τ}^{( 31 )} & {r}_{τ}^{( 32 )} & {r}_{τ}^{( 33 )} & {t}_{τ}^{( 3 )}\end{matrix} ] [ \begin{matrix}x \\ y \\ z \\ 1\end{matrix} ] = [ \begin{matrix}{r}_{τ}^{( 11 )} x + {r}_{τ}^{( 12 )} y + {r}_{τ}^{( 13 )} z + {t}_{τ}^{( 1 )} \\ {r}_{τ}^{( 21 )} x + {r}_{τ}^{( 22 )} y + {r}_{τ}^{( 23 )} z + {t}_{τ}^{( 2 )} \\ {r}_{τ}^{( 31 )} x + {r}_{τ}^{( 32 )} y + {r}_{τ}^{( 33 )} z + {t}_{τ}^{( 3 )}\end{matrix} ]$$

In Equation 3, [symbol] (X) the vector fields 431, and X denotes a 3D coordinate position. Equation 3 may be expressed as Equation 4 below.

$${𝒯}_{τ} ( X ) = {\underbrace{[ \begin{matrix}{r}_{τ}^{( 11 )} x + {r}_{τ}^{( 12 )} y + {t}_{τ}^{( 1 )} \\ {r}_{τ}^{( 21 )} x + {r}_{τ}^{( 22 )} y + {t}_{τ}^{( 2 )} \\ 0\end{matrix} ]}}_{{𝒯}_{τ}^{*} ( u )} + {\underbrace{[ \begin{matrix}{r}_{τ}^{( 13 )} z \\ {r}_{τ}^{( 13 )} z \\ {r}_{τ}^{( 31 )} x + {r}_{τ}^{( 32 )} y + {r}_{τ}^{( 33 )} z + {t}_{τ}^{( 3 )}\end{matrix} ]}}_{{ε}_{τ}^{*}} \qquad Equation 4$$

In Equation 4, [symbol] (u) denotes the 2D transformation components of the vector fields 431, and ε_{τ}(X) denotes the 3D residual components of the vector fields 431. The 2D transformation components of the vector fields 431 may represent a 2D rigid transformation. The 3D residual components of the vector fields 431 may represent a remaining 1 D rigid transformation after the 2D transformation components, [symbol] (u), are removed from the 3D rigid transformation.

Equation 4 may be expressed as Equation 5 below.

$${\tilde{𝒯}}_{τ} ( u ) = π ( {𝒯}_{τ} ( X ) ; K ) = π ( {𝒯}_{τ}^{*} ( u ) + {ε}_{τ} ( X ) ; K ) \qquad Equation 5$$

In Equation 5, [symbol] (u) denotes the vector fields 431, π denotes a projection operation, and K denotes a camera intrinsic parameter. [symbol] (X) may be projected into a 2D space based on K and π. [symbol] (u) may be generated as a result of the projection. The vector fields 431 may be a result of projecting a motion of a 3D space into a 2D space. Thus, the vector fields 431 may be expressed as [symbol] (u). Equation 5 may be expressed as Equation 6 below.

### Equation 6:

$${\tilde{𝒯}}_{τ} ( u ) = C ( {𝒯}_{τ} ( u ) , {ϵ}_{τ} ( u ) )$$

In Equation 6, C may be a merge function that merges two input components. [symbol] (u) may denote a 3D residual component. Thus, the vector fields 431 may have a 3D aware-based characteristic. Equation 6 may be simply expressed as Equation 7 below.

$${\tilde{𝒯}}_{τ} = C ( {𝒯}_{τ} , {ϵ}_{τ} ) = C ( {\underbrace{U + {Δ𝒯}_{τ}}}_{{𝒯}_{τ}} , {ϵ}_{τ} ) = U + {\underbrace{C ( {Δ𝒯}_{τ} , {ϵ}_{τ} )}}_{{δ}_{τ}} = U + {δ}_{τ} \qquad Equation 7$$

In Equation 7, [symbol] may denote a 2D transformation component, and [symbol] may denote a 3D residual component. U may be a known canonical vector field. For example, it may be S=S(U). [symbol] may be estimated using the main neural network 411. The main neural network 411 may be trained to map the blur image 401 to {∈₁, ∈₂, . . . , ∈_{M}}. [symbol] may be estimated using the sub-neural network 412. According to this decomposition scheme, since the 3D residual component may be directly estimated by the main neural network 411, the 3D rigid transformation may be performed without explicit depth measurement.

The main neural network 411 and the sub-neural network 412 may include multiple layers, with one or more layers forming various network components such as a fully connected network (FCN), a convolutional neural network (CNN), a recurrent neural network (RNN), a transformer, and the like. For example, the sub-neural network 412 may include, but is not limited to, a multilayer perceptron (MLP).

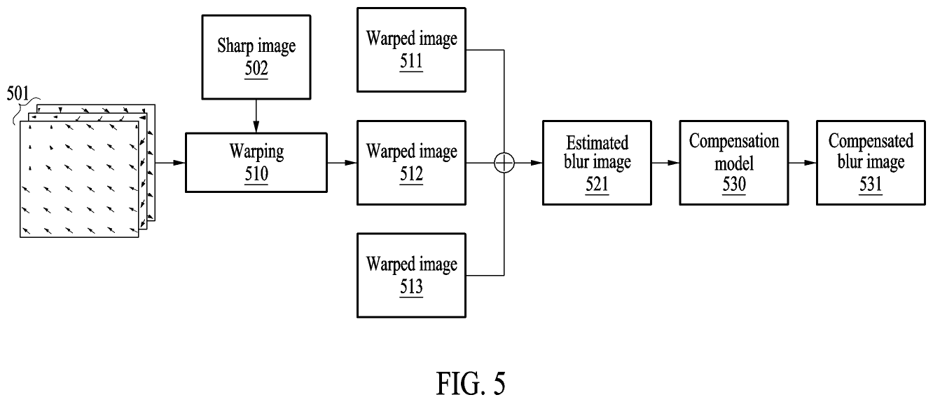

FIG. 5 illustrates an example operation for estimating a blur image using vector fields according to one or more embodiments. Referring to FIG. 5, a warping operation 510 may be performed on a sharp image 502 using vector fields 501. The warping operation 510 may be implemented based on grid sampling, among other techniques. The sharp image 502 may form a training data pair with a corresponding blur image that is used to generate the vector fields 501. Warped images 511 through 513 may be generated as a result of the warping operation 510.

The vector fields 501 may include first, second, and third vector fields. The warped image 511 may be generated using the first vector field, the warped image 512 may be generated using the second vector field, and the warped image 513 may be generated using the third vector field. The warped images 511 through 513 may respectively correspond to image components of the blur image. For example, when the first vector field is generated based on a first image component of the blur image, the warped image 511 may correspond to the first image component.

An estimated blur image 521 may be generated by merging (e.g., averaging) the warped images 511 through 513. A motion estimation model may be trained by adjusting model parameters of the motion estimation model to minimize the difference between the blur image and the estimated blur image 521.

A neural network-based compensation model 530 may be employed to train the motion estimation model. The compensation model 530 may generate a compensated blur image 531 based on the estimated blur image 521. In this context, the motion estimation model may be trained by adjusting the model parameters of the motion estimation model to reduce the difference between the blur image and the compensated blur image 531. The compensation model 530 may train the motion estimation model by improving quality of the estimated blur image 521. For example, the compensation model 530 may compensate for photometric variations between the blur image and the sharp image 502, which may occur due to differences in image sensors, lenses, and color drifts. The estimated blur image 521 may be expressed as Equation 8 below.

$$\tilde{B} = \frac{1}{M} {\sum }_{τ} S ( {\tilde{𝒯}}_{τ} ) \qquad Equation 8$$

In Equation 8, \tilde{B} may denote the estimated blur image 521, [symbol] may denote the vector fields 501, and [symbol] ( [symbol] ) may denote the warped images 511 to 513. M may be a number of the vector fields 501 and the warped images 511 to 513. A blur loss of Equation 9 below may be used to train the motion estimation model.

$${L}_{blur \_ 3 D} = {‖ B - \tilde{B} ‖}_{1} + {‖ B - {h}_{ξ} ( \tilde{B} ) ‖}_{1} \qquad Equation 9$$

In Equation 9, L_{blur_3D} may denote the blur loss, B may denote the blur image, \tilde{B} may denote the estimated blur image 521, and h_{ξ}(\tilde{B}) may denote the compensated blur image 531.

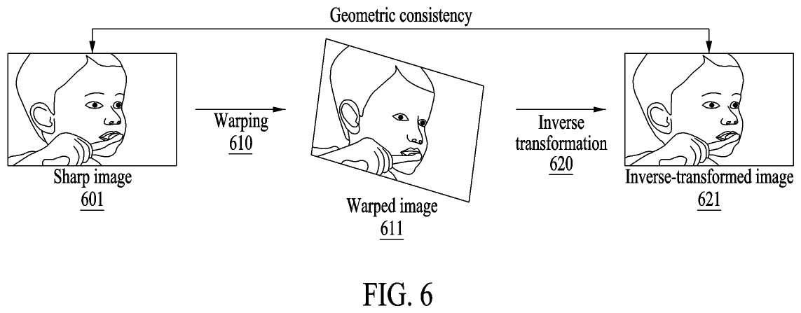

FIG. 6 illustrates an example inverse transformation constraint that ensures geometric consistency according to one or more embodiments. One or more constraints may be applied to reduce/suppress estimation ambiguity in a motion estimation model. For example, although non-parametric vector fields may provide flexibility, their arbitrary characteristic may introduce ambiguity. Accordingly, the constraints may include, for example, an inverse transformation constraint for reducing/minimizing differences between images obtained by applying an inverse transformation using vector fields to warped images and a sharp image. The constraints may also include, for example, a smoothing constraint for reducing/minimizing differences between neighboring vectors within the vector fields. The motion estimation model may be trained based on one or more of the inverse transformation constraint and the smoothing constraint.

A smoothing loss Lₛₘₒₒₜₕ based on the smoothing constraint, such as in Equation 10 below, may be used to train the motion estimation model.

$${L}_{smooth} = {( 4 {\tilde{𝒯}}_{τ} ( x , y ) - {\sum }_{i , j} {\tilde{𝒯}}_{τ} ( x + i , y ) + {\tilde{𝒯}}_{τ} ( x , y + j ) )}^{2} \qquad Equation 10$$

For example, i,j∈{−1,1} may be established, but examples are not limited thereto. According to Equation 10, a difference between a motion vector at a coordinate position (x, y) of a vector field and neighboring motion vectors of the motion vector may be reduced, thereby smoothing irregularities in the vector fields.

A geometric loss L_{geometric} based on the inverse transformation constraint, such as in Equation 11 below, may be used to train the motion estimation model.

$${L}_{geometric} = {\sum }_{τ} {‖ S - {\tilde{S}}_{τ} ( {\tilde{𝒯}}_{τ}^{′} ) ‖}_{1} \qquad Equation 11$$

Referring to FIG. 6, a warped image 611 may be generated by performing a warping operation 610 on a sharp image 601. An inverse-transformed image 621 may be generated by applying an inverse transformation operation 620 on the warped image 611. When the geometric loss L_{geometric} is used, a geometric consistency between the sharp image 601 and the inverse-transformed image 621 is maintained by reducing a difference between the sharp image 601 and the inverse-transformed image 621. [symbol] ( [symbol] ) denotes the inverse-transformed image 621, and [symbol] denotes the inverse transformation operation 620. The inverse transformation operation 620 may be in inverse relation to the warping operation 610. The warping operation 610 and the inverse transformation operation 620 may be performed based on the vector fields.

When both the inverse transformation constraint and the smoothing constraint are used, a total loss Lₜₒₜₐₗ may be determined based on Equation 12 below.

$${L}_{total} = {L}_{blur \_ 3 D} + {λ}_{1} {L}_{smooth} + {λ}_{2} {L}_{geometric} \qquad Equation 12$$

In Equation 12, λ₁ and λ₁ each denote an adjustment weight.

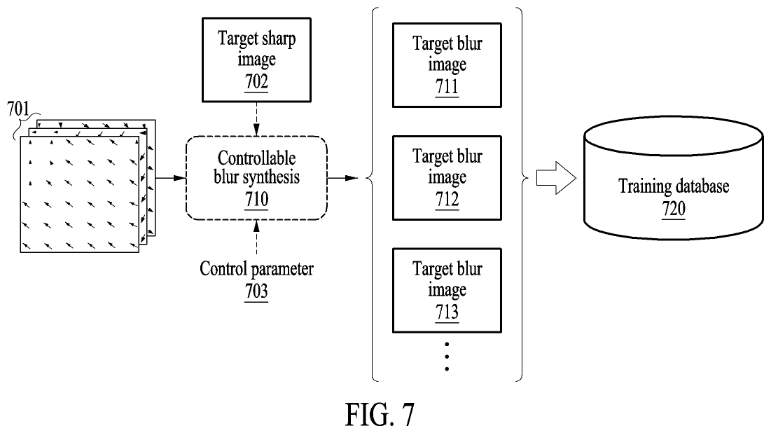

FIG. 7 illustrates an example operation for performing blur synthesis using a control parameter according to one or more embodiments. Referring to FIG. 7, a controllable blur synthesis operation 710 may be performed on a target sharp image 702 based on vector fields 701. The target sharp image 702 may be any sharp image independent of a blur image that is used to generate the vector fields 701. Warped images may be generated by applying a warping operation to the target sharp image 702 using the vector fields 701, and corresponding target blur images 711 through 713 may each be generated by synthesizing the warped images.

The target blur images 711 through 713 may each be paired with the target sharp image 702 and stored in a training database 720 as training data pairs. These training data pairs are used to train a neural network-based deblur model. Training data pairs close to reality may be obtained through 3D aware-based data augmentation. Diversity of the training data pairs may be enhanced by applying the vector fields 701, along with other various vector fields, to various sharp images.

The diversity of the training data pairs may be further enhanced by adjusting blur characteristics of the target blur images 711 through 713 using a control parameter 703. Based on the control parameter 703, one or more of an amplitude and a phase of the vector fields 701 may be adjusted to generate transformed vector fields. New warped images may be generated by warping, using the transformed vector fields, the target sharp image 702. A new target blur image may be generated by synthesizing the new warped images.

For example, when a first parameter set is used as the control parameter 703, a target blur image 711 exhibiting a first blur characteristic may be generated. When a second parameter set or a third parameter set is used as the control parameter 703, a target blur image 712 with a second blur characteristic or a target blur image 713 with a third blur characteristic may be generated, respectively.

A displacement field δ_{τ} of Equation 7 above may be expressed as Equation 13 below.

$${δ}_{τ} = C ( Δ {𝒯}_{τ} , {ϵ}_{τ} ) = \vert Δ {𝒯}_{τ} \vert \cdot \vert {ϵ}_{τ} \vert ∠ ( ϕ ( {Δ𝒯}_{τ} ) + ϕ ( {ϵ}_{τ} ) ) \qquad Equation 13$$

In Equation 13, |⋅| denotes an amplitude of a vector, and φ denotes a function that calculates an angle of the vector. According to Equation 13, controllability of the vector fields 701 may be confirmed. Different versions of target blur images may be generated by adjusting the amplitude and/or an angle of the vector fields 701.

For example, a 3D aware displacement vector δ=(x_{δ}, [symbol] _{δ}) of the vector fields 701 may be determined from Equation 7. Also, δ=|δ|∠φ(δ), which is an amplitude-phase representation of polar coordinates, may be determined.

$$\vert δ \vert = \sqrt{{x}_{δ}^{2} + {y}_{δ}^{2}} and ϕ ( δ ) = {tan}^{- 1} ( \frac{y δ}{x δ} )$$

may be established. Blur vectors of the vector fields 701 may be adjusted by adjusting the amplitude and/or the phase in the amplitude-phase representation. Since an amplitude-phase control may be applied uniformly to an entire area of the vector fields 701, a geometric structure of the vector fields 701 may be preserved, thereby enabling the generation of various blur images without compromising geometric consistency.

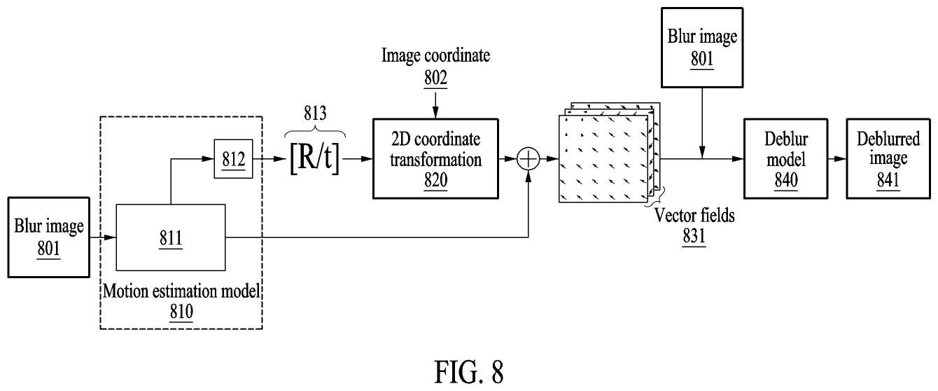

FIG. 8 illustrates an example deblur model employing vector fields according to one or more embodiments. Referring to FIG. 8, a motion estimation model 810 may estimate camera poses 813 for image components corresponding to camera positions along a 3D camera trajectory, wherein these image components form a blur image 801. Parametric vector fields may be generated by performing a 2D coordinate transformation 820 based on the camera poses 813 and an image coordinate 802. The motion estimation model 810 may further estimate non-parametric vector fields. A main neural network 811 of the motion estimation model 810 may be used for estimating the non-parametric vector fields, and the main neural network 811 and a sub-neural network 812 of the motion estimation model 810 may be used for estimating the parametric vector fields. The parametric vector fields and the non-parametric vector fields may be merged to generate vector fields 831.

A neural network-based deblur model 840 may perform deblurring on the blur image 801 based on the blur image 801 and the vector fields 831, thereby generating a deblurred image 841. For example, the blur image 801 and the vector fields 831 may be used as input data of the deblur model 840. The vector fields 831, which possess a 3D aware-based characteristic related to a blur component of the blur image 801, enable the deblur model 840 to accurately analyze the blur component of the blur image 801 and effectively remove the blur component.

In the example of FIG. 8, the deblur model 840 may be trained using not only training data pairs including the blur image 801 and a corresponding sharp image but also the vector fields 831. For example, the deblur model 840 may be trained to receive the blur image 801 and the vector fields 831 as inputs and produce the deblurred image 841 that closely approximates the corresponding sharp image.

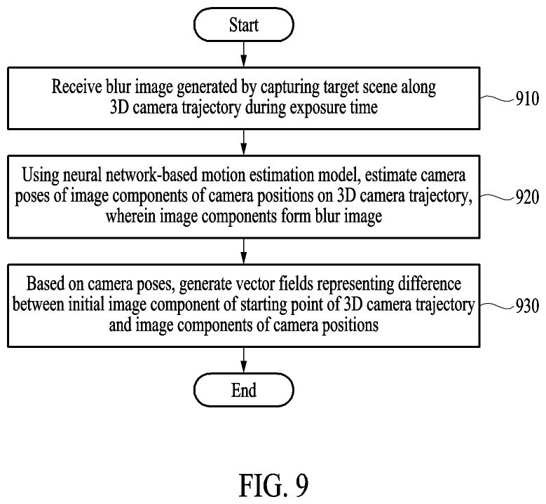

FIG. 9 illustrates an example image processing method employing vector fields according to one or more embodiments. Referring to FIG. 9, in operation 910, an electronic device may receive a blur image generated by capturing a target scene along a camera trajectory. In operation 920, the electronic device may employ a neural network-based motion estimation model to estimate camera poses of image components corresponding to camera positions on a 3D camera trajectory, wherein these image components form the blur image. In operation 930, the electronic device may generate, based on the camera poses, vector fields representing differences between an initial image component at a starting point of the 3D camera trajectory and the image components of the subsequent camera positions.

The electronic device may determine 2D transformation components of the vector fields based on the camera poses, and estimate 3D residual components of the vector fields using the motion estimation model. In operation 930, the vector fields may be generated by fusing the 2D transformation components with the 3D residual components.

The electronic device may generate warped images by applying a warping operation, using the vector fields, to a target sharp image, and generate a target blur image by synthesizing the warped images. The resulting training data pair, which comprises the target sharp image and the target blur image, may be used to train a neural network-based deblur model.

The electronic device may generate transformed vector fields by adjusting one or more of an amplitude and a phase of the vector fields, generate new warped images by applying a warping operation, using the transformed vector fields, to a target sharp image, and generate a new target blur image by synthesizing the new warped images. The blur image and the sharp image may form a training data pair.

The motion estimation model may be trained based on one or more of constraints. The constraints may include an inverse transformation constraint for reducing a difference between images obtained by applying an inverse transformation (using the vector fields) to the warped images and a sharp image, and a smoothing constraint for reducing a difference between neighboring vectors of the vector fields.

The electronic device may generate a deblurred image by executing a neural network-based deblur model using the blur image and the vector fields as inputs.

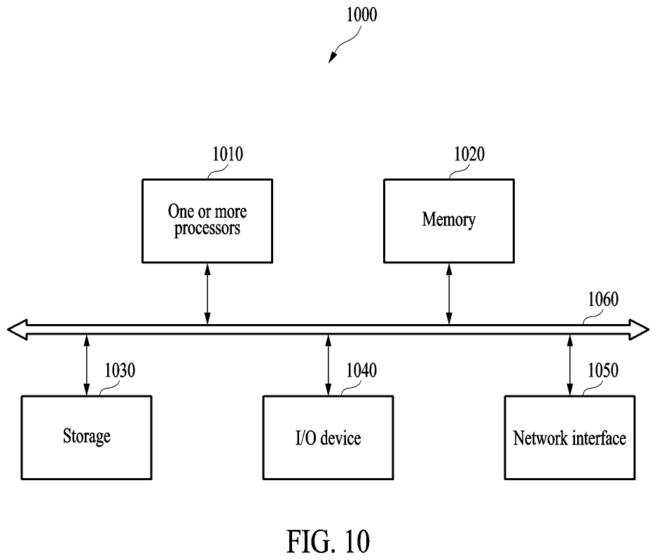

FIG. 10 illustrates an example configuration of an electronic device according to one or more embodiments. Referring to FIG. 7, an electronic device 1000 may include one or more processors 1010, a memory 1020, a storage 1030, an input/output (I/O) device 1040, and a network interface 1050. These components may communicate with one another via a communication bus 1060.

The one or more processors 1010 may respectively comprise processing circuitry to execute instructions stored in the memory 1020 or the storage 1030. When executed by the one or more processors 1010, the instructions may cause the electronic device 1000 to perform the operations described with reference to FIGS. 1 through 9. The memory 1020 may include a non-transitory computer-readable storage medium or a non-transitory computer-readable storage device. The memory 1020 may store instructions (e.g., executable code) to be executed by the one or more processors 1010 and may store related information while software and/or an application is being executed by the electronic device 1000.

The storage 1030 may include a non-transitory computer-readable storage medium or a non-transitory computer-readable storage device. The storage 1030 may store a greater amount of information than the memory 1020 for extended periods. For example, the storage 1030 may include a magnetic hard disk, an optical disc, a flash memory, a floppy disk, or other non-volatile memories known in the art.

The I/O device 1040 may receive user input via conventional methods (e.g., a keyboard and a mouse) as well as via modern methods (e.g., touch, voice, or image input). For example, the I/O device 1040 may include a keyboard, a mouse, a touch screen, a microphone, or any other device that captures and transmits the user input to the electronic device 1000. Additionally, the I/O device 1040 may provide outputs from the electronic device 1000 to the user via visual, auditory, or haptic channels. The I/O device 1040 may include, for example, a display, touch screen, speaker, vibration generator, or any other device that provides the output to the user. The network interface 1050 may facilitate communication with external devices over wired or wireless networks.

The processors, memories, storages, devices network interfaces, communication links/buses, and models described herein, including descriptions with respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented image processing method comprising:
receiving a blur image generated by capturing a target scene along a three-dimensional (3D) camera trajectory during an exposure time;
estimating, using a neural network-based motion estimation model, camera poses corresponding to image components captured at camera positions on the 3D camera trajectory, wherein the image components form the blur image; and
generating, based on the camera poses, vector fields representing a difference between an initial image component captured at a starting point of the 3D camera trajectory and the image components captured at the camera positions.

2. The method of claim 1, further comprising:
determining two-dimensional (2D) transformation components of the vector fields based on the camera poses; and
estimating 3D residual components of the vector fields using the neural network-based motion estimation model.

3. The method of claim 2, wherein the generating of the vector fields comprises:
fusing the 2D transformation components with the 3D residual components.

4. The method of claim 1, further comprising:
generating warped images by warping a target sharp image using the vector fields; and
generating a target blur image by synthesizing the warped images.

5. The method of claim 4, wherein
a training data pair comprising the target sharp image and the target blur image is used to train a neural network-based deblur model.

6. The method of claim 1, further comprising:
generating transformed vector fields by adjusting one or more of an amplitude and a phase of the vector fields;
generating new warped images by warping a target sharp image using the transformed vector fields; and
generating a new target blur image by synthesizing the new warped images.

7. The method of claim 1, further comprising:
generating warped images by warping a sharp image using the transformed vector fields;
generating an estimated blur image by merging the warped images; and
training the neural network-based motion estimation model by adjusting model parameters of the motion estimation model to a difference between the blur image and the estimated blur image,
wherein the blur image and the sharp image form a training data pair.

8. The method of claim 7, wherein
the neural network-based motion estimation model is trained based on one or more of:
an inverse transformation constraint that reduces a difference between images obtained by applying an inverse transformation using the vector fields to the warped images and the sharp image; and
a smoothing constraint that reduces a difference between neighboring vectors of the vector fields.

9. The method of claim 1, further comprising:
based on the blur image and the vector fields, generating a deblurred image by executing a neural network-based deblur model.

10. A non-transitory computer-readable storage medium storing instructions that, when executed by one or more processors, cause the one or more processors to perform the method of claim 1.

11. An electronic device comprising:
one or more processors respectively comprising processing circuitry; and
a memory storing executable code, which upon execution by the one or more processors, configures the one or more processors to:
receive a blur image generated by capturing a target scene along a three-dimensional (3D) camera trajectory during an exposure time;
estimate, using a neural network-based motion estimation model, camera poses corresponding to image components captured at camera positions on the 3D camera trajectory, wherein the image components form the blur image; and
generate, based on the camera poses, vector fields representing a difference between an initial image component captured at a starting point of the 3D camera trajectory and the image components captured at the camera positions.

12. The electronic device of claim 11, wherein the execution of the code by the one or more processors configures the one or more processors:
determine two-dimensional (2D) transformation components of the vector fields based on the camera poses; and
estimate 3D residual components of the vector fields using the motion estimation model.

13. The electronic device of claim 12, wherein the execution of the code by the one or more processors configures the one or more processors:
generate the vector fields by fusing the 2D transformation components with the 3D residual components.

14. The electronic device of claim 11, wherein the execution of the code by the one or more processors configures the one or more processors:
generate warped images by warping a target sharp image using the vector fields; and
generate a target blur image by synthesizing the warped images.

15. The electronic device of claim 14, wherein a neural network-based deblur model is trained using a training data pair comprising the target sharp image and the target blur image.

16. The electronic device of claim 11, wherein the execution of the code by the one or more processors configures the one or more processors:
generate transformed vector fields by adjusting one or more of an amplitude and a phase of the vector fields;
generate new warped images by warping a target sharp image using the vector fields; and
generate a new target blur image by synthesizing the new warped images.

17. The electronic device of claim 11, wherein the execution of the code by the one or more processors configures the one or more processors:
generate warped images by warping a sharp image using the vector fields;
generate an estimated blur image by merging the warped images; and
train the motion estimation model by adjusting model parameters of the motion estimation model to reduce a difference between the blur image and the estimated blur image,
wherein the blur image and the sharp image form a training data pair.

18. The electronic device of claim 17, wherein the motion estimation model is trained based on one or more of:
an inverse transformation constraint that reduces a difference between images obtained by applying an inverse transformation using the vector fields to the warped images and the sharp image; and
a smoothing constraint that reduces a difference between neighboring vectors of the vector fields.

19. The electronic device of claim 11, wherein the execution of the code by the one or more processors configures the one or more processors:
generate a deblurred image based on the blur image and the vector fields by executing a neural network-based deblur model.

20. A method for generating a three-dimensional (3D) aware vector field for a blur image, the method comprising:
capturing a blur image of a target scene along a 3D camera trajectory during an exposure interval;
estimating a vector field representing differences between an initial image component captured at a starting point of the 3D camera trajectory and subsequent image components captured at camera positions along the 3D camera trajectory, the estimating being performed using a neural network-based motion estimation model;
adjusting one or more of an amplitude and a phase of the vector field to generate a controllable vector field; and
using the controllable vector field to configure a training dataset for a deblur model, wherein the training dataset comprises a training data pair including the blur image and a sharp image of the target scene by applying the controllable vector field.

21. An electronic device comprising:
one or more processors; and
a memory storing executable code which, when executed by the one or more processors, cause the electronic device to:
capture a blur image of a target scene along a 3D camera trajectory during an exposure time;
estimate a vector field representing differences between an initial image component captured at a starting point of the 3D camera trajectory and subsequent image components captured at camera positions along the 3D camera trajectory using a neural network-based motion estimation model;
adjust one or more of an amplitude and a phase of the vector field to generate a controllable vector field; and
use the controllable vector field to configure a training dataset for a deblur model, wherein the training dataset comprises a training data pair including the blur image and a sharp image by applying the controllable vector field.
